(19) United States
(12) Patent Application Publication
(10) Pub. No.: US 2006/0141853 A1
(43) Pub. Date: Jun. 29, 2006

(54) Connector for flexible flat strip cables

(76) Inventor: Thomas Bernhard Pabst, Nurnberg (DE)

Correspondence Address: HARRINGTON & SMITH, LLP, 4 RESEARCH DRIVE, SHELTON, CT, 06484-6212, US

(21) Appl. No.: 10/533,344

(22) PCT Filed: Oct. 23, 2003
(86) PCT No.: PCT/EP03/11746

§ 371 Date: Nov. 21, 2005

(30) Foreign Application Priority Data
Oct. 31, 2002 (DE) 102 50 934.4

(51) Int. Cl. H01R 12/24

(52) U.S. Cl. 439/495

(57) ABSTRACT

The present invention relates to a connector (1) for flat flex cables (2), with a housing (3), in which is provided: at least one introduction opening (4) for one end of a flat flex cable, spring contacts (5) for connecting the at least one flat flex cable (2) with contacts (6) or with another flat flex cable (7) and at least one strain relief (8). The strain relief (8) has a slide (9), which is introduced into the introduction opening (4) above the flat flex cable (2), the flat flex cable (2) being bent by a rib (10) on slide (9) into a recess (11) in the bottom of introduction opening (4) until the slide (9) locks into its final position on housing (3).

The present invention concerns connectors for flat flex cables according to the preamble of patent claim 1.

Such a connector is known, for example, from GB-1,317,264 B1. The connector described therein has, in a housing, spring contacts which are pressed against regions of the flat flex cable that are stripped of insulation, while the opposite-lying ends of these spring contacts are in the shape of female connectors for the uptake of male connectors. The connection of two flat flex cables with one another is carried out by direct contact of the parts of the flat flex cable that are stripped of insulation. The overall structure of the connector described therein has proven to be complicated with respect to its handling and an effective strain relief cannot be recognized.

The object of the present invention is to extensively improve a connector of this type such that its handling is simplified and a secure strain relief is continually assured in the case of the flat flex cables that participate in it.

This object is solved according to the claims.

Features of preferred embodiments of the present invention are characterized in the subclaims. The concept of the invention is based on the following: when the connector is introduced into its final position, the one or more flat flex cables that participate in it are clamped into a “baffle plate”, in which the cables are very sharply bent locally, so that the adhesion friction forces that occur in the strain loading are so great that a tearing out of the flat flex cable from the connector can be effectively prevented. The operator who assembles the connector recognizes the obtaining of the final position by the “clicking in” of the connector elements.

In the following, the invention will be explained in more detail based on the description of three embodiments of the present invention with reference to the drawing. The following are shown therein:

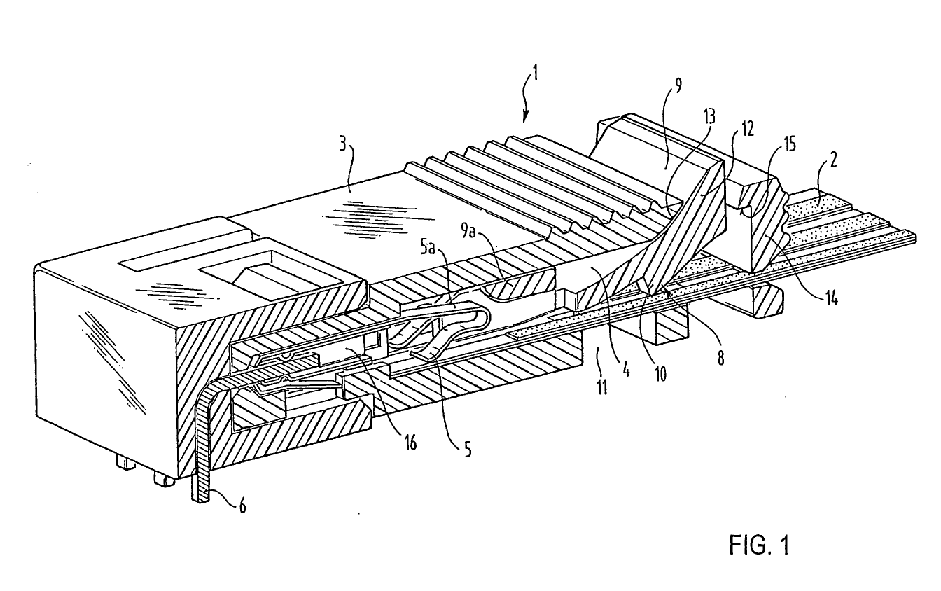

FIG. 1 shows a perspective view, which is partially cut away, of a first embodiment of the connector according to the invention;

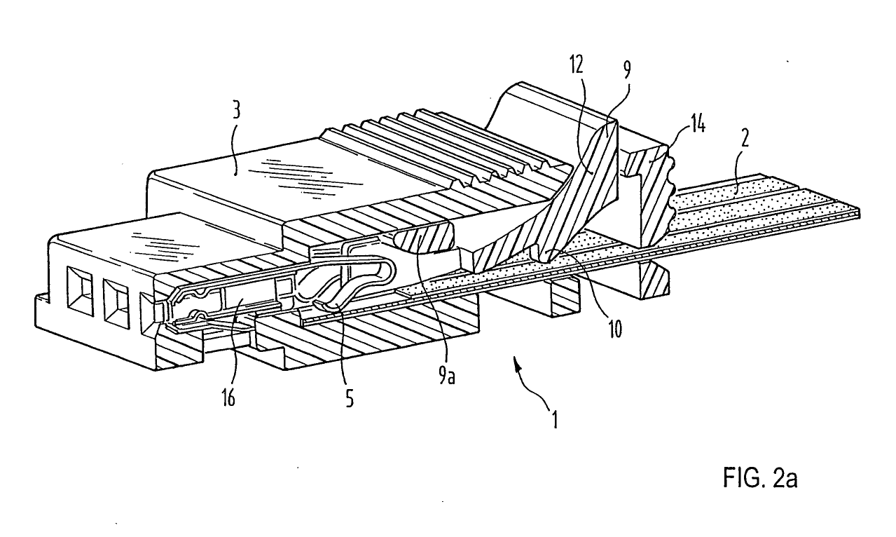

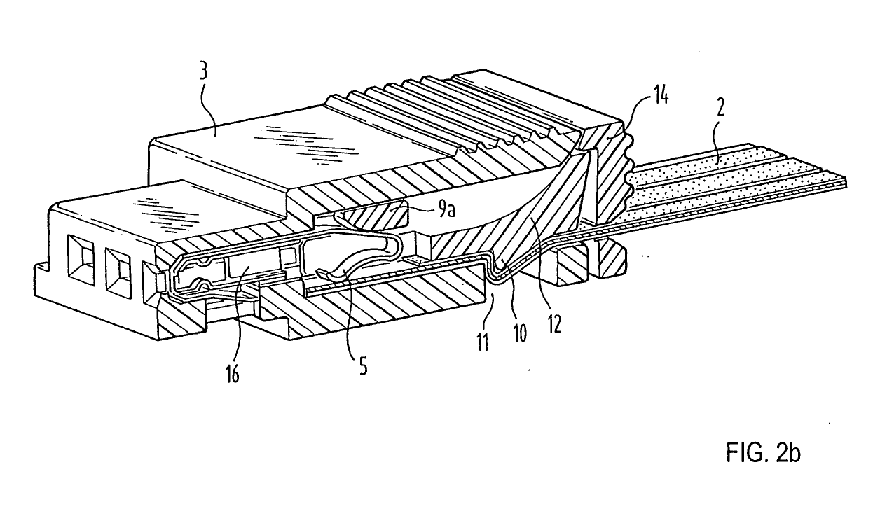

FIG. 2 shows the connector according to FIG. 1 in the pre-locking position and in the final position;

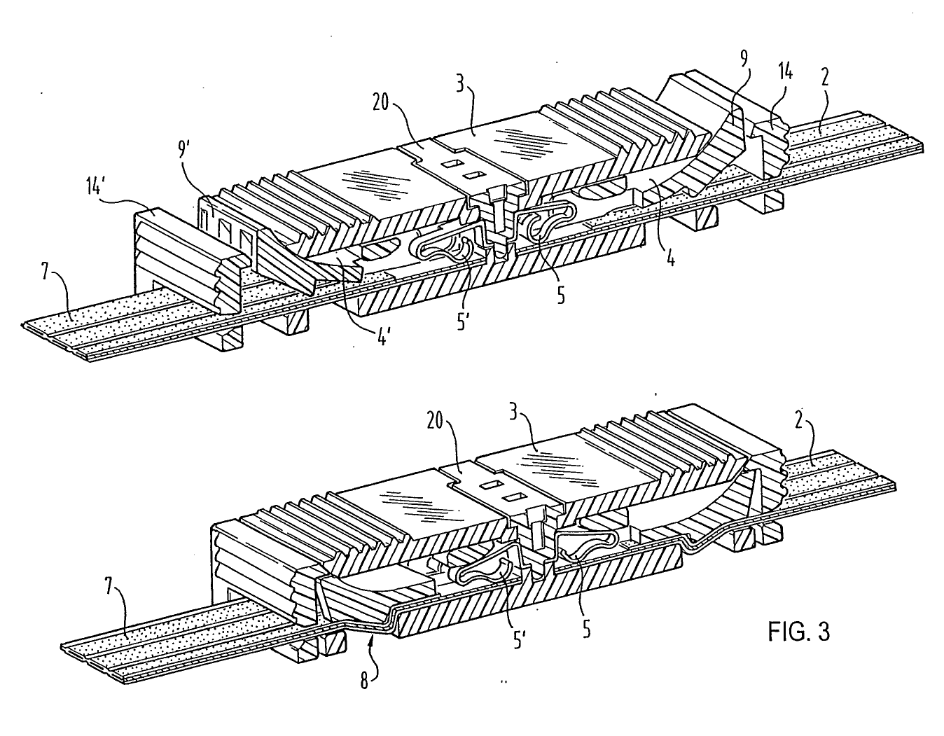

FIG. 3 shows another embodiment of the present invention in the pre-locking position and in the final locked position; and

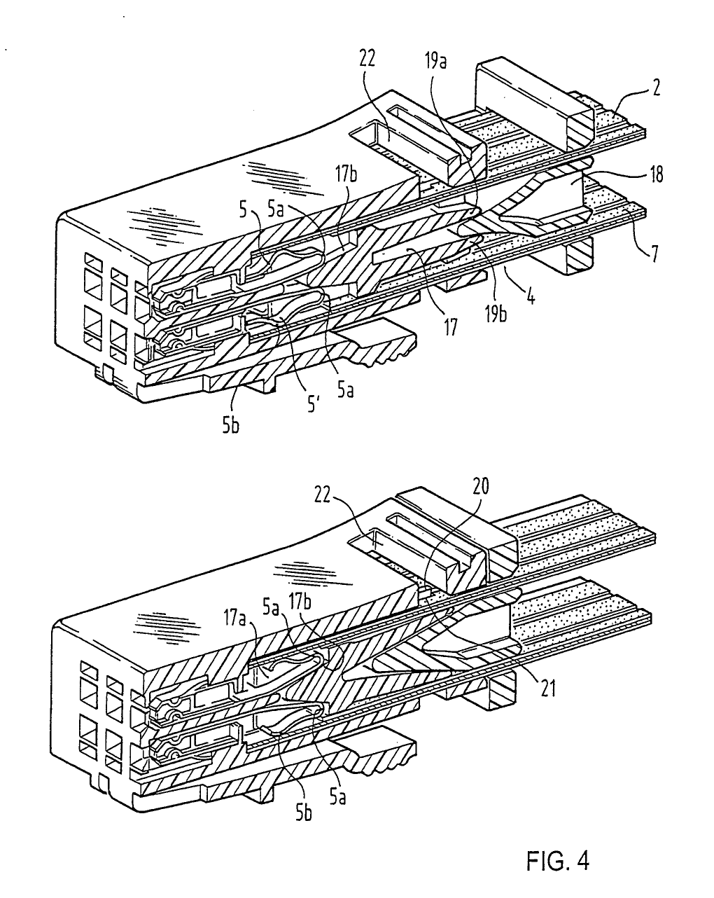

FIG. 4 shows a third embodiment of a connector according to the present invention in perspective view, which is partially cut away, in the pre-locking position and in the final locked position.

The connector 1 shown in FIG. 1 has a housing 3, with an introduction opening 4 for a flat flex cable 2. The latter is inserted into the introduction opening 4 until it strikes the end of the opening. At its head end, the flat flex cable 2 has conductive tracks stripped of insulation, onto which press the spring contacts 5. In addition to the flat flex cable 2, a slide 9, which has several functions, is introduced into the introduction opening 4. First of all, it effects a strain relief of the flat flex cable 2, which is described in more detail below, and secondly, it presses the spring contacts 5 more strongly onto the conductive tracks of the flat flex cable 2, which are stripped of insulation. The strain relief is effected by a ramp 12 at the back end of the slide, viewed in the insertion direction, which, with its back end, projects up over the introduction opening 4, when it is in the position prior to assembly. On its bottom side, ramp 12 has a rib 10 running crosswise to the insertion direction. In the final locked position, this rib 10 lies opposite a recess 11 or a passage 11 in the bottom of housing 3. In addition, the slide 9 has on its end an operating surface 14 with a gap, through which the flat flex cable 2 is conducted. The operating surface 14 serves as the surface for an operator to introduce force by pressing on the operating surface in the insertion direction, until the slide 9 locks into its final position. On the way to this final position, ramp 12 is pressed downward through the upper edge of the introduction opening 4, so that the cross-rib 10 presses the flat flex cable 2 into the recess or into the passage 11. The pre-locking position and the final position are shown in FIG. 2. It can be clearly recognized in FIG. 2b that the cross rib 10, in its final position, comes to lie tightly at the front edge of the recess or opening 11, viewed in the insertion direction, so that the flat flex cable 2 experiences an almost 90-degree bend, which represents an effective strain relief.

In final position, the upper back edge of the slide 9 locks under a shoulder 15, which is provided in the operating surface 14.

In the region of its head end, slide 9 also has an additional two ramps 9a, which, when slide 9 is inserted into the introduction opening 4, press the legs 5a situated at the ends of pressure springs 5 located away from flat flex cable 2 and press the entire essentially U-shaped spring contacts 5 in the direction onto the flat flex cable 2. In this way, a more stable and more secure electrical contact is assured between the contact springs 5 and the conductive tracks of the flat flex cable 2, which are stripped of insulation.

In the embodiments shown in FIGS. 1 and 2, the spring contacts 5 have contact sockets 16 at their sides that are not in contact with the flat flex cable 2, which are arrested in corresponding openings in the housing 3, for contacting the flat flex cable 2 with male connectors of a complementary connector.

FIG. 3 shows an embodiment of a connector according to the invention, with which two flat flex cables 2, 7 can be connected with one another. FIG. 3 shows the pre-locking position (upper left) and the final locked position (lower right). As can be readily seen, the structure of this connector differs from that shown in FIGS. 1 and 2 only by the fact that a mirror-symmetric doubling has occurred, with two anti-parallel introduction openings 4, 4′ in a housing 3 and with spring contacts 5, 5′, whose back ends are joined together, or which are made up in one piece from the outset. The strain relief function and the pressing of spring contacts 5, 5′ onto the parts of flat flex cables 2, 7 which are stripped of insulation are described identically to those with reference to FIGS. 1 and 2. The spring contacts 5, 5′ in this embodiment are fastened by means of an arresting part 2* that can be introduced crosswise to the insertion direction on housing 3 in a way known in and of itself. That is, there results a fixing of position in the locked final position of fastening part 20 in housing 3.
sic; 20?—Trans. Note.

FIG. 4 shows a third embodiment of a connector according to the invention, in which two flat flex cables 2, 7 can be inserted into introduction opening 4 and push onto two rows of spring contacts 5, 5′ which are disposed in a mirror-symmetric manner and each of which is formed in just the same way as in the first embodiment. In distinction to the first embodiment, here the two flat flex cables 2, 7 are guided by means of an intermediate member 17 and a slide 18 connecting thereto and fastened. On its head end, the intermediate member 17 has shoulders, with which the legs 5b of the spring contacts which are adjacent to the conductive tracks are pressed onto the conductive tracks. The intermediate member 17 is slotted on its back end along a central plane parallel to the extension of the flat cable. The wedge-shaped tip of slider 18 engages in this slot, so that the back end of the intermediate member 17 is propped open and thus the flat flex cables 2, 7 press against the inner walls of the introduction opening 4.

Here, at the back ends of the slotted parts of the intermediate member, strain relief projections 20 are provided, which engage in corresponding openings 21, which are punched at the appropriate distance in the sides of the flat flex cables. The projections thus pass through the openings in flat flex cables 2, 7 and enter cross slots 22, which are also incorporated at this level in housing 3. The slide 18 is locked in its final position on housing 3 in a way known in and of itself, so that both a high pressing force of the contact springs as well as a secure strain relief are assured.

In the example of embodiment shown in FIG. 4, contact sockets are also formed at the other ends on spring contacts 5. This is not to be understood as limiting, however; contact pins or even contact springs for connecting several flat flex cables 2, 7, as in the second example of embodiment, could just as well be arranged.

The three embodiment examples explained above show the broad field of application of the present invention, wherein the description of the embodiment examples also only serves for purposes of illustration and is not to be construed as limiting.

1. A connector for flat flex cables with a housing, in which is provided at least one introduction opening for a flat flex cable end, spring contacts for connecting the at least one flat flex cable with contacts or another flat flex cable and at least one strain relief, is hereby characterized in that
the strain relief has a slide, which is introduced into the introduction opening over the flat flex cable, wherein the flat flex cable is bent by a rib on slide into a recess at the bottom of the introduction opening until the slide locks in its final position on housing.

2. The connector according to claim 1, further characterized in that the slide, proceeding backward from its tip, forms a ramp, whose back end projects above the level of the opening during introduction into the opening and slides on the upper edge of the opening of the introduction opening, whereby the rib is pressed into the recess.

3. The connector according to claim 1, further characterized in that the slide has, on its back end, an operating surface for pressing it in, at the upper edge of which is disposed a shoulder for the locking of ramp.

4. The connector according to claim 1, further characterized in that the spring contacts at the head end of the introduction opening prestressed perpendicular to its longitudinal axis press on regions of the conductive tracks of the flat flex cable that are stripped of insulation.

5. The connector according to claim 4, further characterized in that the spring contacts are essentially bent in U-shape and their legs located away from the flat flex cable are pressed onto the flat flex cable by two ramps on slide.

6. The connector according to claim 4, further characterized in that the spring contacts are formed on their ends pointing away from the introduction opening as female connectors or plug contacts.

7. The connector according to claim 4, further characterized in that the spring contacts are bent in U-shape at both of their ends and two introduction openings are disposed with their head ends abutting one another in housing for connecting two flat flex cables.

8. The connector according to claim 1, further characterized in that the introduction opening takes up two flat flex cables, and two rows of spring contacts are provided one above the other.

9. The connector according to claim 8, further characterized in that the spring contacts are held by an intermediate member in the introduction opening, and this member can be moved to the head end of the introduction opening by a slider and can be propped open at its back ends, in order to press strain relief projections disposed therein into corresponding openings punched in the flat flex cables.

10. The connector according to claim 9, further characterized in that at the level of openings in the flat flex cables, housing has slots, into which the strain relief projections of intermediate member can be moved.

11. The connector according to claim 8, further characterized in that the spring contacts are bent convexly at their legs that can be pressed onto flat flex cables and are pressed by shoulders of intermediate member onto the flat flex cables.

12. The connector according to claim 11, further characterized in that on its head end, the intermediate member has ramps, with which the legs of spring contacts located away from the flat flex cables are to be pressed onto the flat flex cables.

13. The connector according to claim 8, further characterized in that the slide can be locked in its final position on housing.
